(19) United States
(12) Patent Application Publication
(10) Pub. No.: US 2023/0319876 A1
(43) Pub. Date: Oct. 5, 2023

(54) BASE STATION, BASE STATION SYSTEM, AND COMMUNICATION METHOD

(71) Applicant: NIPPON TELEGRAPH AND TELEPHONE CORPORATION, Tokyo (JP)

(72) Inventors: Yasuhiko INOUE, Musashino-shi, Tokyo (JP); Kengo NAGATA, Musashino-shi, Tokyo (JP); Akira KISHIDA, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/016,603

(22) PCT Filed: Jul. 27, 2020
(86) PCT No.: PCT/JP2020/028675

§ 371 Date: Jan. 17, 2023

(51) Int. Cl. H04W 74/08; H04B 7/0452

(52) U.S. Cl. CPC H04W 74/0808; H04B 7/0452

(57) ABSTRACT

A base station according to an aspect of the present invention operates as a first base station (121) in a base station system (12) including the first base station (121) and a plurality of second base stations (122), the base station including a carrier sensing control unit (66) that determines whether a channel of each of the plurality of second base stations (122) is in an idle state or a busy state by using an access parameter common to the plurality of second base stations (122), and a processing unit (63) that transmits a first signal to be transmitted to a first wireless terminal (14) and a second signal to be transmitted to a second wireless terminal (14) using multi-user MIMO which uses the two or more second base stations (122) whose channels have been determined to be in the idle state in a coordinated manner.

### TECHNICAL FIELD

The present invention relates to a wireless communication technology.

### BACKGROUND ART

A wireless local area network (LAN) terminal is connected to a network via a base station that is an access point (AP). When a plurality of base stations are installed close to each other, the base stations can be segregated from each other by having the base stations use different frequency channels. However, since frequency bands are limited, adjacent base stations may use the same frequency channel.

A base station and a terminal using the same frequency channel perform carrier sensing using Carrier-Sense Multiple Access with Collision Avoidance (CSMA/CA) before transmitting signals to avoid interference. Carrier sensing is performed on the transmission side. Even when two wireless stations (e.g., base stations) on the transmission side detect that a channel is in an idle state and then transmit signals, interference is likely to occur in the wireless station on the reception side (e.g., a terminal).

### CITATION LIST

### Non Patent Literature

Non Patent Literature 1: IEEE Std 802.11-2016, “21.3.11 SU-MIMO and DL-MU-MIMO Beamforming”, Dec. 7, 2016

### SUMMARY OF INVENTION

### Technical Problem

In a case where a plurality of base stations are installed such that service areas overlap, if the plurality of base stations simultaneously transmit signals, interference occurs in a terminal located in the overlapping area, and the terminal may not successfully receive a target signal.

### Solution to Problem

A base station according to an aspect of the present invention operates as a first base station in a base station system including the first base station and a plurality of second base stations, the base station including a carrier sensing control unit configured to determine whether a channel of each of the plurality of second base stations is in an idle state or a busy state by using an access parameter common to the plurality of second base stations, and a processing unit configured to transmit a first signal to be transmitted to a first wireless terminal and a second signal to be transmitted to a second wireless terminal using multi-user MIMO which uses the two or more second base stations whose channels have been determined to be in the idle state in a coordinated manner.

### Advantageous Effects of Invention

According to one aspect of the present invention, interference that occurs in a wireless terminal on the reception side can be reduced.

### BRIEF DESCRIPTION OF DRAWINGS

FIG. 1 is a diagram illustrating a wireless communication system according to an embodiment of the present invention.

FIG. 2 is a block diagram illustrating a hardware configuration example of a master base station illustrated in FIG. 1.

FIG. 3 is a block diagram illustrating a hardware configuration example of a slave base station illustrated in FIG. 1.

FIG. 4 is a block diagram illustrating a hardware configuration example of a wireless terminal illustrated in FIG. 1.

FIG. 5 is a diagram illustrating processing of a MAC layer during communication between a base station system and the wireless terminal illustrated in FIG. 1.

FIG. 6 is a block diagram illustrating a functional configuration example of the master base station illustrated in FIG. 1.

FIG. 7 is a diagram showing an example of communication state information held by a terminal management unit illustrated in FIG. 6.

FIG. 8 is a block diagram illustrating a functional configuration example of a slave base station illustrated in FIG. 1.

FIG. 9 is a flowchart showing processing for determining a slave base station to be used for transmission by the master base station illustrated in FIG. 1.

FIG. 10 is a diagram illustrating an example of processing of the master base station illustrated in FIG. 1 to perform transmission based on a carrier sensing result.

FIG. 11 is a flowchart showing processing of the master base station illustrated in FIG. 1 to transmit a signal.

### DESCRIPTION OF EMBODIMENTS

Embodiments of the present invention will be described below referring to the drawings.

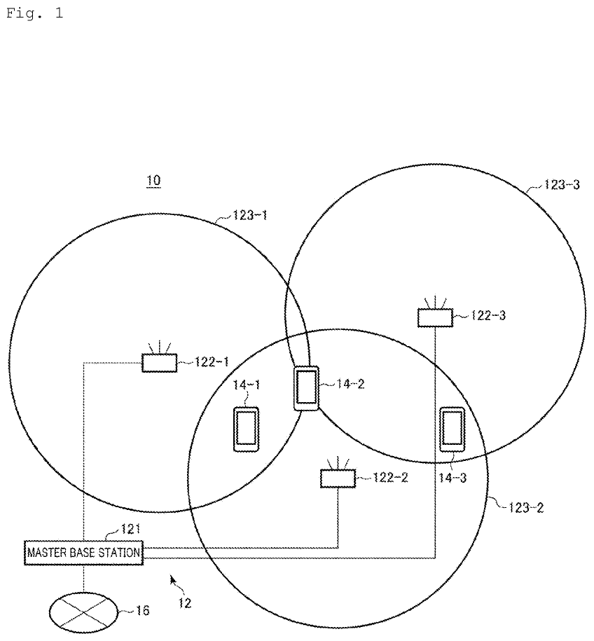

FIG. 1 schematically illustrates a wireless communication system 10 according to an embodiment of the present invention. The wireless communication system 10 is provided with a base station system 12 and wireless terminals 14 as illustrated in FIG. 1. Although the three wireless terminals 14-1, 14-2, and 14-3 are illustrated in FIG. 1, the number of wireless terminals 14 may vary dynamically.

Each wireless terminal 14 is a terminal device having a wireless communication function. The wireless terminal 14 may be a portable wireless terminal such as a smartphone, a tablet, a notebook PC, or the like. The wireless terminal 14 may be a fixed wireless terminal such as a desktop PC. Hereinafter, the wireless terminals will be simply referred to as terminals.

The base station system 12 operates as one access point (AP) for the terminals 14. The base station system 12 is connected to a network 16 such as the Internet, and the terminals 14 access the network 16 via the base station system 12. For example, the terminals 14 exchange data with a server (not shown) on the network 16 via the base station system 12.

The base station system 12 includes a master base station 121 and a plurality of slave base stations 122. The slave base stations 122 are disposed at different geographical locations. The slave base stations 122 form individual service areas 123. Each of the service areas 123 corresponds to a range covered by a radio signal transmitted by the slave base station 122. A certain service area 123 may partially overlap another service area 123, and in the present embodiment, a case where these areas overlap will be described. The master base station 121 may be connected to the slave base stations 122 using cables such as coaxial cables or optical fibers. As a method for connecting the master base station 121 and the slave base stations 122, for example, Radio on Fiber (RoF) may be used.

In the example illustrated in FIG. 1, three slave base stations 122-1, 122-2, and 122-3 are provided. Alternatively, two or four or more slave base stations 122 may be provided. Service areas 123-1, 123-2 and 123-3 of the slave base stations 122-1, 122-2, and 122-3 partially overlap each other. In the snapshot illustrated in FIG. 1, the terminal 14-1 is located in the overlapping area of the service areas 123-1 and 123-2, the terminal 14-2 is located in the overlapping area of the service areas 123-1, 123-2, and 123-3, and the terminal 14-3 is located in the overlapping area of the service areas 123-2 and 123-3.

The master base station 121 functions as a high-order AP, and the slave base stations 122 function as low-order APs. For example, the master base station 121 performs processing of a logical link control (LLC) layer and processing of a first portion of a medium access control (MAC) layer. The processing of the first portion of the MAC layer includes generation of a MAC frame, data extraction from the MAC frame, management of terminal attribution, and setting, maintenance, and notification of a parameter (e.g., an access parameter). The slave base stations 122 perform processing of a second portion of the MAC layer and processing of a physical (PHY) layer. The slave base stations 122 transmit radio signals to the terminals 14 or receive radio signals from the terminals 14.

When communicating with the terminals 14, the slave base stations 122 use MAC addresses allocated in wireless modules of the master base station 121 as their own MAC addresses. In other words, the radio signals transmitted from each of the slave base stations 122 include the same MAC address in the field storing a MAC address of the AP. This can be achieved by the master base station 121 generating a MAC frame.

The slave base stations 122 use the same frequency channel. A frequency channel, a modulation scheme, and a coding scheme are designated by the master base station 121. The slave base stations 122 transmit beacons including the same information (e.g., the same basic service set identifier (BSSID)). The terminals 14 detect the presence of the APs by receiving the beacons. The terminals 14 access a channel according to the information included in the beacons (e.g., channel identification information and access parameters), and perform authentication and association with the base station system 12. As a result, a wireless link is established between the terminals 14 and the base station system 12. The establishment of the wireless link may be performed via any slave base station 122. Thereafter, the terminals 14 exchange data with the base station system 12.

The base station system 12 can simultaneously transmit a plurality of pieces of data addressed to the plurality of terminals 14 by performing multi-user multiple input multiple output (MU-MIMO) transmission using the plurality of slave base stations 122 in a coordinating manner. For example, it is assumed that the master base station 121 has received first data addressed to the terminal 14-1 and second data addressed to the terminal 14-2 from the network 16. In this case, the master base station 121 performs MU-MIMO transmission by using the slave base stations 122-1 and 122-2 in a coordinating manner to transmit the first and second data to the terminals 14-1 and 14-2, respectively. In contrast to this configuration, in a case where the slave base station 122-1 transmits a radio signal including the first data and the slave base station 122-2 simultaneously transmits a radio signal including the second data without performing coordinative MU-MIMO transmission, mutual interference occurs in the overlapping area of the service areas 123-1 and 123-2, and thus the terminal 14-1 and/or 14-2 is not capable of successively receiving the signal(s). Coordinative MU-MIMO transmissions using a plurality of slave base stations 122 can reduce such mutual interference.

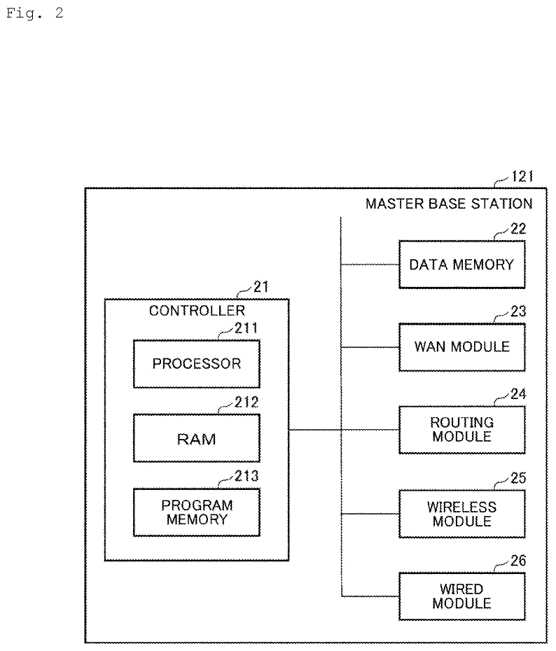

FIG. 2 schematically illustrates a hardware configuration example of the master base station 121. The master base station 121 includes a controller 21, a data memory 22, a wide area network (WAN) module 23, a routing module 24, a wireless module 25, and a wired module 26 as illustrated in FIG. 2.

The controller 21 performs data processing and controls other hardware components. The controller 21 includes a processor 211, a random access memory (RAM) 212, and a program memory 213.

Although the processor 211 may be a general-purpose processor such as a central processing unit (CPU), it is not limited thereto. A dedicated processor, such as an application specific integrated circuit (ASIC), a field programmable gate array (FPGA), or the like may be used. The controller 21 may include two or more processors.

The RAM 212 is used by the processor 211 as a working memory. The RAM 212 includes a volatile memory such as a synchronous dynamic random access memory (SDRAM) or the like. The program memory 213 stores programs to be executed by the processor 211 such as firmware. As the program memory 213, for example, a read-only memory (ROM) may be used.

The controller 21 operates in accordance with a program. For example, the processor 211 loads a program stored in the program memory 213 in the RAM 212, and interprets and executes the program to perform data processing and control.

The data memory 22 stores data. The data memory 22 includes, for example, a nonvolatile memory such as a flash memory. A partial area of the data memory 22 may be used as the program memory 213.

The WAN module 23 is a module including an interface for the master base station 121 to communicate with a server, which is not illustrated, through the network 16. The WAN module 23 is configured to be connected to the network 16 via an optical line, for example.

The routing module 24 is configured to be connected to the WAN module 23 and to perform routing according to destination information of an IP packet from the WAN module 23. The master base station 121 may not include the routing module 24. The master base station 121 may be configured to access a router provided outside the master base station 121 through wireless communication or wired communication, and to be connected to the network 16 through the router.

The wireless module 25 is configured to perform processing related to wireless communication with the terminals 14. The wireless module 25 can conform to a wireless LAN standard such as Wi-Fi. The wireless module 25 includes a processing circuit including a processor and a memory. The wireless module 25 may be provided in the form of a chipset, for example. The wireless module 25 performs processing for establishing a wireless link to the terminals 14 including authentication and association. In addition, the wireless module 25 receives data from the controller 21, generates a MAC frame based on the received data, and transmits the generated MAC frame to any of the slave base stations 122. The MAC frame includes the MAC address of the AP and a frame check sequence (FCS). The MAC address of the AP is stored in the header of the MAC frame. The MAC address of the AP may be a MAC address allocated to the wireless module 25. In addition, the wireless module 25 extracts data from a MAC frame transmitted from a terminal 14 via any of the slave base stations 122 and transfers the extracted data to the controller 21.

The wired module 26 is configured to perform processing for wired communication with the slave base stations 122. For example, the wired module 26 is connected to each of the slave base stations 122 by cables. A coaxial cable, Radio on Fiber (RoF), or the like can be used as a connection scheme. When RoF is used as a connection scheme, the wired module 26 includes an electric-optical (E/O) converter that converts an electric signal to an optical signal and an optical-electric (O/E) converter that converts an optical signal to an electric signal. As long as it is configured such that signals transmitted from the wired module 26 are received by a target slave base station among the slave base stations 122 and signals transmitted from the slave base stations 122 are received by the wired module 26, the wired module 26 may adopt any wired communication scheme.

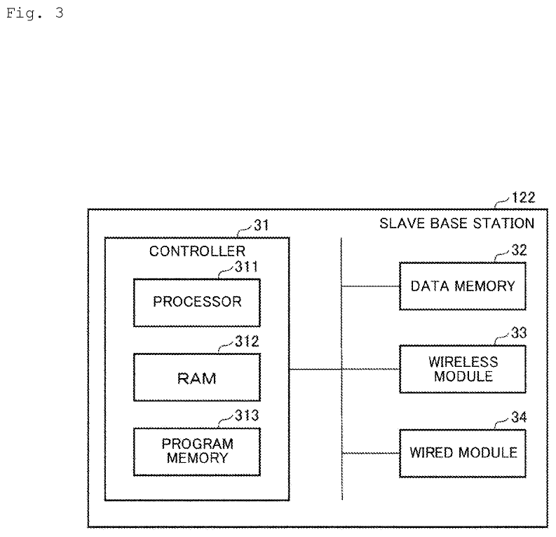

FIG. 3 schematically illustrates a hardware configuration example of a slave base station 122. The slave base station 122 illustrated in FIG. 3 corresponds to each of the slave base stations 122 illustrated in FIG. 1. The slave base station 122 includes a controller 31, a data memory 32, a wireless module 33, and a wired module 34 as illustrated in FIG. 3.

The controller 31 performs data processing and controls other hardware components. The controller 31 includes a processor 311, a RAM 312, and a program memory 313.

The processor 311 may be a general-purpose processor such as a CPU or a dedicated processor such as an ASIC or an FPGA. The controller 31 may include two or more processors.

The RAM 312 is used by the processor 311 as a working memory. The RAM 312 includes a volatile memory such as an SDRAM. The program memory 313 stores programs such as firmware. As the program memory 313, for example, a ROM may be used. The controller 31 operates in accordance with a program. For example, the processor 311 loads a program stored in the program memory 313 in the RAM 312, and interprets and executes the program to perform data processing and control.

The data memory 32 stores data. For example, a flash memory may be used as the data memory 32. A partial area of the data memory 32 may be used as the program memory 313.

The wireless module 33 is configured to perform processing related to wireless communication. The wireless module 33 can conform to a wireless LAN standard such as Wi-Fi. The wireless module 33 includes a processing circuit including a processor and a memory, a radio frequency (RF) circuit, and an antenna. The wireless module 33 may be provided in the form of a chipset. The wireless module 33 receives a MAC frame from the master base station 121 via the wired module 34, converts the MAC frame into a radio signal using the RF circuit, and emits the radio signal via the antenna. Before conversion, the wireless module 33 adds a physical header to the MAC frame. In addition, the wireless module 33 receives a radio signal via the antenna, extracts a MAC frame from the received radio signal, and transmits the extracted MAC frame to the master base station 121.

The wired module 34 is configured to perform processing for wired communication with the master base stations 121. For example, the wired module 34 is connected to the master base station 121 through a cable. A coaxial cable, RoF or the like can be used as a connection scheme. In a case where RoF is used as a connection scheme, the wired module 34 includes an electro-optical converter and an optical-electric converter. As long as it is configured that signals transmitted by the wired module 34 are received by the master base station 121, and signals transmitted by the master base station 121 are received by the wired module 34, the wired module 34 may adopt any wired communication scheme.

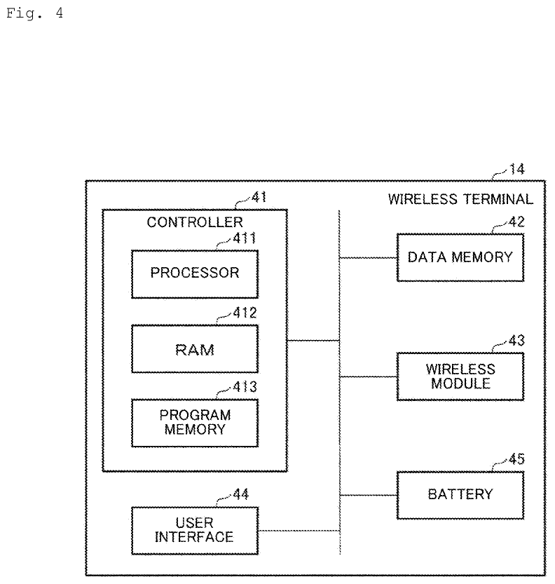

FIG. 4 schematically illustrates a hardware configuration example of a terminal 14. The terminal 14 illustrated in FIG. 4 corresponds to each terminal 14 illustrated in FIG. 1. In the example illustrated in FIG. 4, the terminal 14 is a mobile terminal. The terminal 14 includes a controller 41, a data memory 42, a wireless module 43, a user interface 44, and a battery 45.

The controller 41 performs data processing and controls other hardware components. The controller 41 includes a processor 411, a RAM 412, and a program memory 413.

The processor 411 may be a general-purpose processor such as a CPU or a dedicated processor such as an ASIC or an FPGA. The controller 41 may include a plurality of processors. The RAM 412 is used by the processor 411 as a working memory. The RAM 412 includes a volatile memory such as an SDRAM. The program memory 413 stores programs such as an operating system (OS), firmware, and an application. As the program memory 413, for example, a ROM may be used.

The controller 41 operates in accordance with a program. For example, the processor 411 loads a program stored in the program memory 413 in the RAM 412, and interprets and executes the program to perform data processing and control.

The data memory 42 stores data. As the data memory 42, for example, a hard disk drive (HDD) or a flash memory may be used. A partial area of the data memory 42 may be used as the program memory 413.

The wireless module 43 is configured to perform processing related to wireless communication. The wireless module 43 can conform to a wireless LAN standard such as Wi-Fi. The wireless module 43 includes a processing circuit including a processor and a memory, an RF circuit, and an antenna. The wireless module 43 may be provided in the form of a chipset.

The wireless module 43 performs processing for establishing a wireless link to the base station system 12 including authentication and association. In addition, the wireless module 43 receives data from the controller 41, generates a MAC frame based on the received data, converts the MAC frame into a radio signal using the RF circuit, emits the radio signal through the antenna. The MAC frame includes a MAC address and a frame check sequence (FCS) allocated to the wireless module 43. The MAC address is stored in the header of the MAC frame. In addition, the wireless module 43 receives a radio signal through the antenna, extracts data from the received radio signal, and transmits the extracted data to the controller 41.

The user interface 44 is an interface for exchanging information with the user. As an example, the user interface 44 includes a touch screen, a speaker, and a microphone. The touch screen includes a display and a touch panel.

The battery 45 may be a rechargeable battery, such as a lithium ion secondary battery. The battery 45 supplies power to other hardware components.

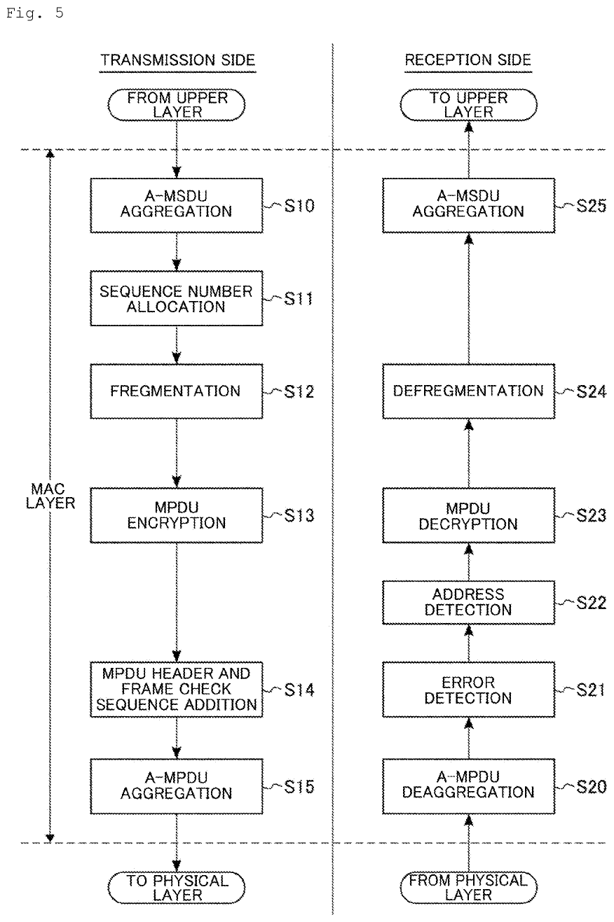

FIG. 5 is a diagram illustrating MAC layer processing during communication between the base station system 12 and the terminal 14. The MAC layer processing illustrated in FIG. 5 is performed following the IEEE 802.11 standard. In FIG. 5, processing performed by both the transmission side and the reception side is shown. When the wireless module of one of the base station system 12 and the terminal 14 performs transmission-side processing, the wireless module of the other performs reception-side processing. In the following example, the transmission-side and reception-side wireless modules will be described without making distinctions between the two.

First, the transmission-side processing will be described. In step S10, the wireless module performs A-MSDU aggregation. Specifically, the wireless module concatenates multiple LLC packets input from the LLC layer to generate an Aggregate-MAC service data unit (A-MSDU).

In step S11, the wireless module allocates a sequence number (SN) to an A-MSDU. The sequence number is a unique number for identifying the A-MSDU.

In step S12, the wireless module fragments (splits) the A-MSDU into multiple MAC protocol data units (MPDUs).

In step S13, the wireless module encrypts each of the MPDUs to generate encrypted MPDUs.

In step S14, the wireless module adds a MAC header and a frame check sequence (FCS) to each encrypted MPDU. The frame check sequence is, for example, a cyclic redundancy check (CRC) code.

In step S15, the wireless module performs A-MPDU aggregation. Specifically, the wireless module concatenates the multiple MPDUs to generate an aggregate-MAC protocol data unit (A-MPDU) as a MAC frame.

After step S15, the wireless module performs physical layer processing on the MAC frame.

When the transmission side is the base station system 12 in the above-described transmission-side processing, the wireless module 25 of the master base station 121 performs the MAC layer processing from step S11 to step S15, and the wireless module 33 of the slave base station 122 performs physical layer processing. In addition, when the transmission side is the terminal 14, the wireless module 43 of the terminal 14 performs the MAC layer processing from step S10 to step S15 and the physical layer processing.

The reception-side processing will be described next. When a radio signal is received, the wireless module performs physical layer processing to acquire a MAC frame from the radio signal. The wireless module then performs the MAC layer processing illustrated in FIG. 5.

In step S20, the wireless module performs A-MPDU deaggregation. Specifically, the wireless module fragments the A-MPDU into units of MPDUs.

In step S21, the wireless module performs error detection. For example, the wireless module performs CRC to determine whether the radio signal has been successfully received. If the reception of the radio signal has failed, the wireless module may make a retransmission request. At this time, the wireless module may request retransmission in units of MPDUs. On the other hand, if the reception of the wireless signal has succeeded, the wireless module performs the next processing.

In step S22, the wireless module performs address detection. At this time, the wireless module determines whether the transmitted MPDUs are addressed to that wireless module itself based on the addresses recorded in the MAC headers of the MPDUs. If the MPDUs are not addressed to the wireless module itself, the wireless module does not perform the next processing. If the MPDUs are addressed to the wireless module itself, the wireless module performs the next processing.

In step S23, the wireless module decrypts the encrypted MPDUs.

In step S24, the wireless module defragments the MPDUs. In other words, the wireless module reconstructs the A-MSDU from the multiple MPDUs.

In step S25, the wireless module performs A-MSDU deaggregation. Specifically, the wireless module reconstructs the LLC packets in units of MSDUs from the A-MSDU.

After step S25, the wireless module outputs the LLC packets to the upper layer over the MAC layer. The upper layer is the LLC layer, for example.

In the above-described reception-side processing, when the reception side is the base station system 12, the wireless modules 33 of the slave base station 122 performs the physical layer processing and the MAC layer processing from step S20 to step S22, and the wireless modules 25 of the master base station 121 performs the MAC layer processing from step S23 to step S25. In addition, when the reception side is the terminal 14, the wireless module 43 of the terminal 14 performs the physical layer processing and the MAC layer processing from step S20 to step S25.

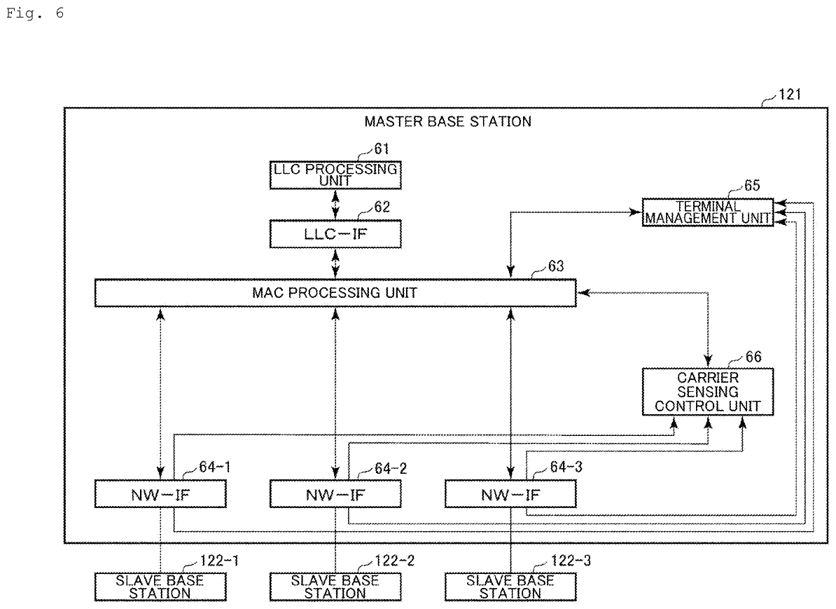

FIG. 6 schematically illustrates a functional configuration example of the master base station 121. The master base station 121 includes an LLC processing unit 61, an LLC interface 62, a MAC processing unit 63, network interfaces 64, a terminal management unit 65, and a carrier sensing control unit 66 as illustrated in FIG. 6. These are realized by, for example, the controller 21, the wireless module 25, and the wired module 26 illustrated in FIG. 2.

The LLC processing unit 61 performs LLC layer processing for wireless communication with the terminals 14. In downlink transmission, when the master base station 121 receives data addressed to a terminal 14 from a server on the network 16, the LLC processing unit 61 receives the data from an upper layer of the master base station 121 and generates LLC packets including the data. The generation of LLC packets includes processing of adding a destination service access point (DSAP) header and a source service access point (SSAP) header to the data. In uplink transmission, the LLC processing unit 61 extracts data from LLC packets and transmits the extracted data to an upper layer. The upper layer is, for example, the application layer.

The LLC interface 62 relays signals between the LLC processing unit 61 and the MAC processing unit 63. The LLC interface 62 may include a queue. The LLC interface 62 receives LLC packets from the LLC processing unit 61, temporarily stores the LLC packets in the queue, and transmits the LLC packets to the MAC processing unit 63. In addition, the LLC interface 62 receives LLC packets from the MAC processing unit 63, temporarily stores the LLC packets in the queue, and transmits the LLC packets to the LLC processing unit 61.

The MAC processing unit 63 performs MAC layer processing for wireless communication with the terminals 14. In downlink transmission, the MAC processing unit 63 receives LLC packets from the LLC processing unit 61 via the LLC interface 62, and generates a MAC frame including the LLC packets. The generation of the MAC frame is performed according to, for example, the processing from step S10 to step S15 illustrated in FIG. 5. The MAC processing unit 63 selects a slave base station 122 to be used for transmission of the MAC frame from among the slave base stations 122 in accordance with a carrier sensing result notified by the carrier sensing control unit 66 which will be described below. The MAC processing unit 63 transmits the MAC frame to the selected slave base station 122 via the network interface 64.

An MU-MIMO that coordinates the plurality of slave base stations 122 includes performing beamforming with the antennas of the slave base stations 122, and the MAC processing unit 63 determines a transmission weight for the beamforming. The transmission weight is a coefficient to be superimposed on a signal to be transmitted by the antenna. The transmission weight is determined, for example, as follows. The MAC processing unit 63 transmits a known signal for channel estimation (e.g., a sounding signal) to the terminal 14 via the slave base station 122. The terminal 14 receives the known signal from the slave base station 122, and performs channel estimation based on the known signal. In order to determine a transmission weight for the plurality of slave base stations 122 to perform coordinative MU-MIMO, each terminal 14 needs to perform channel estimation with each slave base station 122 capable of receiving the known signal and notify the master base station 121 of the channel estimation. The MAC processing unit 63 receives the channel estimation result from the terminal 14 via the slave base station 122. The MAC processing unit 63 calculates a transmission weight from information of the channel between the antenna of each of the plurality of slave base stations 122 used for coordinative MU-MIMO transmission and the antenna of each of the plurality of terminals 14 to be destinations. The MAC processing unit 63 calculates a transmission weight such that each terminal 14 cancels a signal addressed to another terminal 14. The MAC processing unit 63 notifies the slave base station 122 of the transmission weight. The MAC processing unit 63 may determine a transmission weight using a method different from the method described above.

The MAC processing unit 63 transmits information necessary for PHY processing to the slave base station 122. The information necessary for PHY processing may include information indicating a modulation and coding scheme (MCS), information indicating a frequency channel, and information indicating a transmission weight. The information indicating an MCS specifies a modulation scheme and a coding scheme to be used.

In uplink transmission, the MAC processing unit 63 receives a MAC frame from the slave base station 122 via the network interface 64, and extracts LLC packets from the MAC frame. The extraction of the LLC packets is performed according to the processing from step S22 to step S25 illustrated in FIG. 5. The MAC processing unit 63 then transmits the LLC packets to the LLC processing unit 61 via the LLC interface 62.

The network interface 64 exchanges signals with the slave base station 122. In the example illustrated in FIG. 6, the network interface 64-1 exchanges signals with the slave base station 122-1, the network interface 64-2 exchanges signals with the slave base station 122-2, and the network interface 64-3 exchanges signals with the slave base station 122-3. The network interface 64 is realized by the wired module 26 illustrated in FIG. 2, and communicates with the slave base station 122 by wire. When RoF is used as a connection scheme, the network interface 64 performs electro-optical conversion on a signal to be transmitted to the slave base station 122. Further, the network interface 64 performs optical-electric conversion on the signal received from the slave base station 122.

The network interface 64 receives a MAC frame from the MAC processing unit 63 and transmits the MAC frame to the slave base station 122. In addition, the network interface 64 receives a MAC frame from the slave base station 122 and transmits the MAC frame to the MAC processing unit 63. Further, the network interface 64 receives carrier sensing information from the slave base station 122 and transmits the carrier sensing information to the carrier sensing control unit 66. The network interface 64 receives, from the slave base station 122, information indicating a reception power for the terminal 14 (e.g., a received signal strength indicator (RSSI)) for the terminal 14 and transmits the information to the terminal management unit 65. The network interface 64 has a queue, and the queue temporarily stores a signal to be transmitted to the slave base station 122 (e.g., a MAC frame), and temporarily stores a signal (e.g., a MAC frame) received from the slave base station 122.

The terminal management unit 65 manages a state of communication between a terminal 14 belonging to the AP and the slave base station 122. In the present embodiment, the communication state is classified into three states, that is, primary, secondary, and communication-disabled states. The primary and secondary states correspond to a state in which the slave base station 122 can communicate with the terminal 14.

The terminal management unit 65 manages the correspondence relation based on the reception power related to each terminal 14 notified of by each slave base station 122. For example, the slave base station 122 measures an RSSI of a signal received from the terminal 14, and the terminal management unit 65 receives information indicating the RSSI related to the terminal 14 from the slave base station 122, and determines whether communication with the terminal 14 is possible based on comparison between the RSSI and a threshold. The terminal management unit 65 determines a slave base station 122 having the highest RSSI among communicable slave base stations 122 as a primary station, and determines the rest communication-disabled slave base stations 122 as secondary stations. The terminal management unit 65 transmits information indicating the terminal 14 to be handled to the slave base station 122 determined as a primary station with respect to the terminal 14.

Each terminal 14 mainly exchanges signals with the master base station 121 via the slave base station 122 determined as a primary station for the terminal. For example, when receiving a radio signal from the terminal 14, the slave base station 122 determines whether the slave base station 122 itself is a primary station for the terminal 14. When the slave base station 122 itself is a primary station for the terminal 14, the slave base station 122 transmits the MAC frame extracted from the received radio signal to the master base station 121. At this time, the slave base station 122 transmits Ack to the terminal 14 in response to reception of the radio signal. On the other hand, when the slave base station 122 is not a primary station for the terminal 14, the slave base station 122 may discard the received radio signal.

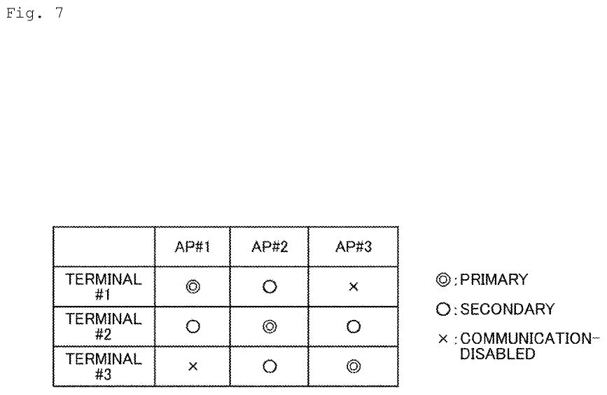

FIG. 7 schematically shows communication state information held by the terminal management unit 65. The communication state information shown in FIG. 7 corresponds to the state illustrated in FIG. 1 in which the terminals 14-1, 14-2, and 14-3 belong to an AP. In the example illustrated in FIG. 7, with respect to the terminal 14-1 (terminal #1), the slave base station 122-1 (AP #1) is a primary state, the slave base station 122-2 (AP #2) is a secondary station, and the slave base station 122-3 (AP #3) is a communication-disabled station. With respect to the terminal 14-2 (terminal #2), the slave base station 122-2 is a primary station, and the slave base station 122-1 and the slave base station 122-3 are secondary stations. With respect to the terminal 14-3 (terminal #3), the slave base station 122-3 is a primary station, the slave base station 122-2 is a secondary station, and the slave base station 122-1 is a communication-disabled station.

The terminal management unit 65 may update the communication state information at an any timing. When the communication state information is updated, the terminal management unit 65 transmits the updated communication state information to the MAC processing unit 63. For example, when the terminal 14-1 approaches the slave base station 122-2, the RSSI of the terminal 14-1 with respect to the slave base station 122-2 becomes higher than the RSSI of the terminal 14-1 with respect to the slave base station 122-1. In this case, the terminal management unit 65 changes the primary station for the terminal 14-1 from the slave base station 122-1 to the slave base station 122-2, and notifies the slave base station 122-2 of the fact that the slave base station 122-2 is the primary station for the terminal 14-1.

Referring again to FIG. 6, the carrier sensing control unit 66 receives carrier sensing information from the slave base stations 122 via the network interface 64, and performs carrier sensing for each slave base station 122 based on the carrier sensing information. Carrier sensing is processing for detecting a channel use state, and it is determined whether a channel is a free state (an idle state) or a busy state. The carrier sensing may be performed using clear channel assessment (CCA), for example. CCA is a method for determining a channel use state based on an RSSI. In this case, each slave base station 122 measures the RSSI of the channel, and the carrier sensing information includes the measured value of the RSSI.

A carrier sensing control unit 66 performs carrier sensing for each of the slave base stations 122 by using an access parameter common to the slave base stations 122. As an access control method, for example, CSMA/CA or enhanced distribution channel access (EDCA) can be used. Different access parameter sets are set in four access categories (ACs) in EDCA, and EDCA is executed independently for each of the access categories. The four access categories include AC VO (Voice), AC_VI (Video), AC_BE (Best Effort), and AC_BK (Background). The parameter sets include Cwmax, Cwmin, AIFS, and TXOPLimit. CWmax and CWmin is a maximum value and a minimum value of a contention window (CW) that is a transmission waiting time for avoiding a collision. An arbitration inter-frame space (AIFS) is a fixed transmission waiting time set for each access category for collision avoidance control provided with a priority control function. TXOPLimit is an upper limit value of a transmission opportunity (TXOP) that is a channel occupancy time.

The carrier sensing control unit 66 determines that the channel is in the idle state when the RSSI is lower than the threshold over a carrier sensing period, and otherwise, determines that the channel is in the busy state. The carrier sensing period is obtained by adding a random back-off period to the AIFS. The random back-off period is obtained by multiplying a unit slot time by a random number. The carrier sensing control unit 66 transmits information (e.g., an identifier) specifying the slave base station 122 having the channel being in the idle state to the MAC processing unit 63 as a carrier sensing result.

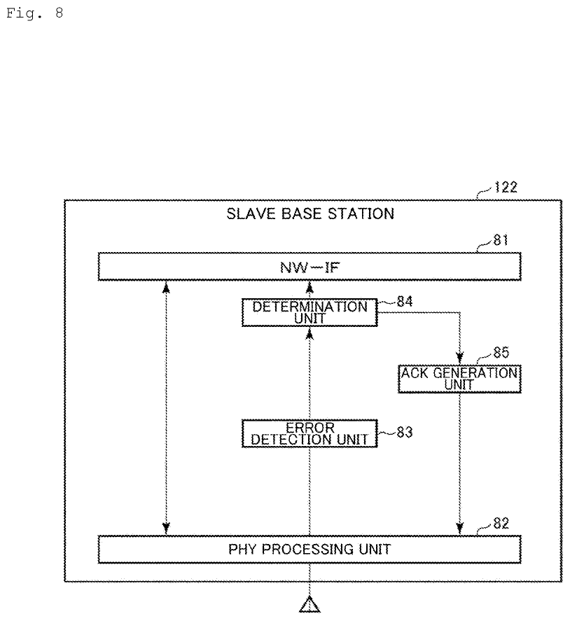

FIG. 8 schematically illustrates a functional configuration example of the slave base station 122. The slave base station 122 illustrated in FIG. 8 corresponds to each of the slave base stations 122 illustrated in FIG. 1. The slave base station 122 includes a network interface 81, a PHY processing unit 82, an error detection unit 83, a determination unit 84, and an ACK generation unit 85 as illustrated in FIG. 8. These are realized by, for example, the wireless module 33 and the wired module 34 illustrated in FIG. 3.

The network interface 81 exchanges signals with the master base station 121. The network interface 81 is realized by the wired module 34 illustrated in FIG. 3, and communicates with the master base station 121 by wire. When RoF is used as a connection scheme, the network interface 81 performs optical-electric conversion on a signal received from the master base station 121. In addition, the network interface 81 performs electro-optical conversion on a signal to be transmitted to the master base station 121.

The network interface 81 receives a signal from the master base station 121 and transmits the signal to the PHY processing unit 82. The signal may be, for example, information necessary for a MAC frame or PHY processing. The information necessary for PHY processing may include information indicating an MCS, information indicating a frequency channel, and information indicating a transmission weight. In addition, the network interface 81 receives a signal from the PHY processing unit 82 or the determination unit 84, and transmits the signal to the master base station 121. The signal may be, for example, a MAC frame, carrier sensing information, or the like. The network interface 81 has a queue, and the queue temporarily stores a signal received from the master base station 121 and temporarily stores a signal to be transmitted to the master base station 121.

The PHY processing unit 82 performs physical layer processing for wireless communication with the terminal 14. In downlink transmission, the PHY processing unit 82 receives a MAC frame from the master base station 121 via the network interface 81, converts the MAC frame into a radio signal, and transmits the radio signal to the terminal 14. When the base station system 12 performs coordinative MU-MIMO transmission, the PHY processing unit 82 performs beamforming based on a transmission weight notified by the master base station 121. For the beamforming processing, for example, a zero-forcing method, a maximum likelihood detection (MLD) method, a minimum mean square error (MMSE) method, or the like can be applied. In uplink transmission, the PHY processing unit 82 receives radio signals from the terminal 14, extracts a MAC frame from the radio signal, and transmits the MAC frame to the error detection unit 83.

Furthermore, the PHY processing unit 82 measures information necessary for performing carrier sensing to generate carrier sensing information. For example, the PHY processing unit 82 measures the RSSI, and the carrier sensing information includes the measured value of the RSSI. The PHY processing unit 82 transmits carrier sensing information to the master base station 121 via the network interface 81. The PHY processing unit 82 also broadcasts beacons.

The error detection unit 83 detects errors in the MAC frame in order to determine whether the signal transmitted from the terminal 14 has been successfully received. The error detection is performed using an FCS included in the MAC frame. The error detection may be carried out in units of MPDUs. When there is no error in the MAC frame, the error detection unit 83 transmits the MAC frame to the determination unit 84, and requests the ACK generation unit 85 to generate an acknowledgment (ACK) indicating the successful reception. On the other hand, when there is an error in the MAC frame, the error detection unit 83 discards the MAC frame.

The determination unit 84 receives the MAC frame from the error detection unit 83, decodes the header of the MAC frame, and acquires the address of the destination and the address of the transmission source. The determination unit 84 receives information indicating the terminal 14 associated with the slave base station itself as a primary station from the master base station 121 via the network interface 81. The determination unit 84 determines whether the station (the slave base station 122) itself is a primary station for the terminal 14 which is the transmission source of the MAC frame based on the address of the transmission source and the information received from the master base station 121. Furthermore, the determination unit 84 determines whether the destination of the MAC frame is the station (the base station system 12) itself based on the address of the destination. When the station itself is a primary station for the terminal 14 of the transmission source and the destination is the station itself, the determination unit 84 transmits the MAC frame to the network interface 81 and transmits a notification to the ACK generation unit 85. When the station itself is not a primary station for the terminal 14 of the transmission source or the destination is not the station itself, the determination unit 84 may discard the MAC frame and does not transmit a notification to the ACK generation unit 85.

The ACK generation unit 85 generates an ACK in response to the request from the error detection unit 83 and the notification from the determination unit 84, and transmits the ACK to the PHY processing unit 82. Upon receiving the ACK from the error detection unit 83, the PHY processing unit 82 transmits the ACK to the terminal 14.

The ACK may be a block ACK. In this case, the error detection unit 83 performs error detection on each piece of data included in the MAC frame in units of MPDUs, the ACK generation unit 85 generates a bitmap indicating the result of the error detection, and transmits the bitmap to the PHY processing unit 82 as a block ACK.

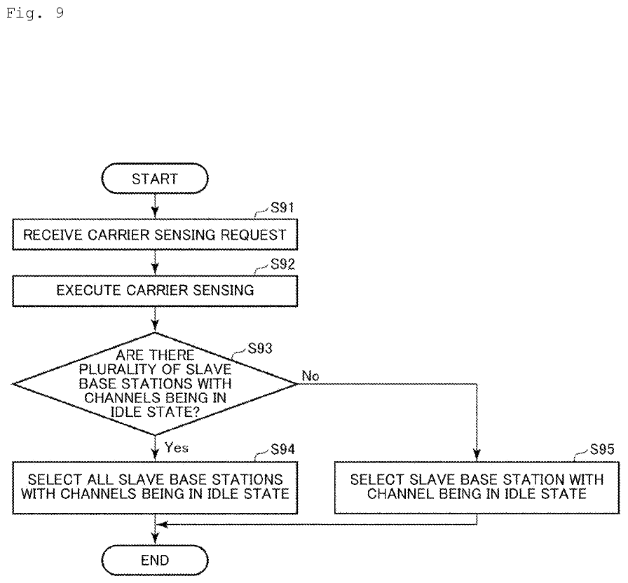

FIG. 9 schematically shows processing to determine a slave base station 122 to be used for signal transmission by the master base station 121.

In a step S91 of FIG. 9, the carrier sensing control unit 66 receives a carrier sensing request. For example, upon receiving data (LLC packets) to be transmitted from the LLC processing unit 61, the MAC processing unit 63 generates a MAC frame from the data, and requests the carrier sensing control unit 66 to execute carrier sensing.

In a step S92, the carrier sensing control unit 66 executes carrier sensing for each of the slave base stations 122 in response to the carrier sensing request. For example, the carrier sensing control unit 66 first determines a carrier sensing period. The carrier sensing control unit 66 obtains a carrier sensing period by adding a random back-off period to an AIFS. When the RSSI indicated by the carrier sensing information received from the slave base station 122 is lower than a threshold over the carrier sensing period, the carrier sensing control unit 66 determines that the channel is in the idle state, and otherwise determines that the channel is in a busy state. The carrier sensing control unit 66 transmits the identifier of one or a plurality of slave base stations 122 whose channels have been determined to be in the idle state to the MAC processing unit 63.

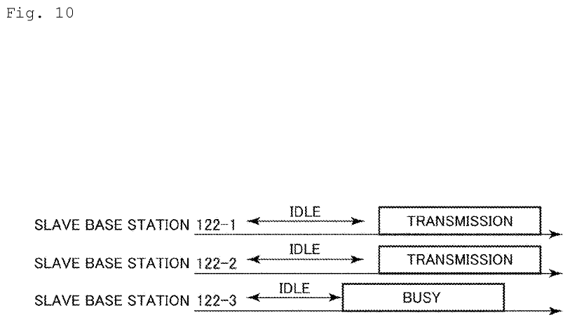

If there are a plurality of slave base stations 122 whose channels have been determined to be in the idle state (step S93; Yes), the processing proceeds to step S94. In a step S94, the MAC processing unit 63 selects all of the plurality of slave base stations 122 whose channels have been determined to be in the idle state as slave base stations 122 to be used for transmission. In the example illustrated in FIG. 10, when carrier sensing is completed, the channels of the slave base stations 122-1 and 122-2 are in the idle state, and the channel of the slave base station 122-3 is in the busy state. In this case, the slave base stations 122-1 and 122-2 are selected.

Returning to FIG. 9, if there is one slave base station 122 whose channel is determined to be in the idle state (step S93; No), the processing proceeds to step S95. In a step S95, the MAC processing unit 63 selects one slave base station 122 whose channel is determined to be in the idle state as a slave base stations 122 to be used for transmission.

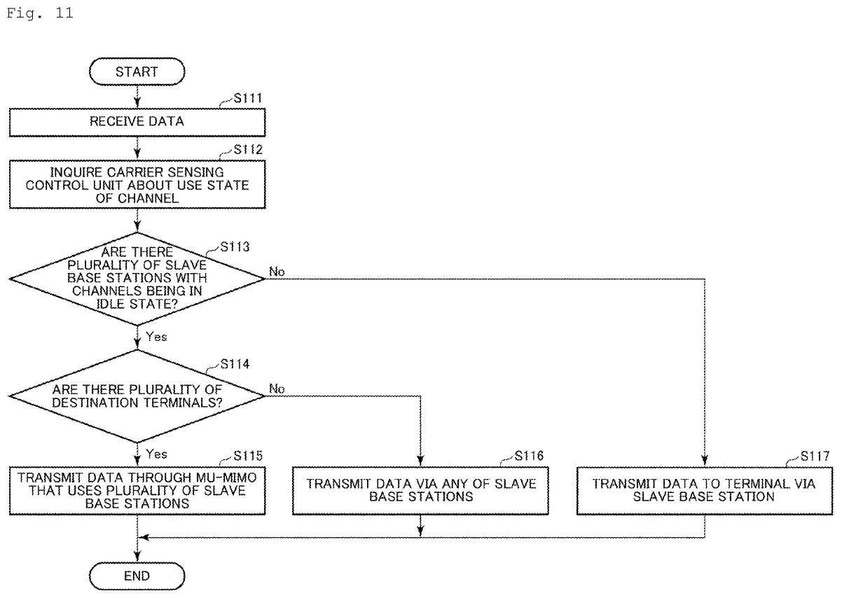

FIG. 11 schematically illustrates processing of the master base station 121 to transmit data. In a step S111 of FIG. 11, the MAC processing unit 63 receives data (LLC packets) to be transmitted to the terminal 14 from the LLC processing unit 61. For example, the MAC processing unit 63 receives first data that is data addressed to the terminal 14-1, and generates a first MAC frame including the first data.

In a step S112, the MAC processing unit 63 inquires the carrier sensing control unit 66 about the use state of the channel of each slave base station 122. In response to this, the carrier sensing control unit 66 executes carrier sensing as described in the step S92 of FIG. 9.

Before receiving the carrier sensing result from the carrier sensing control unit 66, the MAC processing unit 63 may further receive second data that is data addressed to the terminal 14-2 from the LLC processing unit 61. The MAC processing unit 63 generates a second MAC frame including the second data.

If there is one slave base station 122 whose channel is determined to be in the idle state (step S113; No), the processing proceeds to step S117. In step S117, the MAC processing unit 63 transmits the data to the terminal 14 via the slave base station 122 whose channel is determined to be in the idle state. For example, the MAC processing unit 63 specifies the terminal for which the slave base station 122 whose channel is determined to be in the idle state is set as a primary station from among the plurality of terminals belonging to the access point, and determines to transmit a signal to be transmitted to the specified terminal. In the example illustrated in FIG. 7, the terminal for which the slave base station 122-1 is set as a primary station is the terminal 14-1. If it is determined that the slave base station 122-1 has the channel being in the idle state, the MAC processing unit 63 determines to transmit the data addressed to the terminal 14-1 by using the slave base station 122-1.

If the slave base station 122-1 has been determined to have the channel being in the idle state, the MAC processing unit 63 specifies that the slave base station 122-1 is a primary station for the terminal 14-1 based on the communication state information notified by the terminal management unit 65, and determines to transmit the first data. The MAC processing unit 63 transmits a first MAC frame to the slave base station 122-1, and the slave base station 122-1 converts the first MAC frame received from the MAC processing unit 63 into a radio signal, and emits the radio signal via the antenna.

When the MAC processing unit 63 has received the first data and the second data and the slave base station 122-2 having the channel being in the idle state has been determined, the MAC processing unit 63 specifies that the slave base station 122-2 is a primary station for the terminal 14-2, and determines to transmit the second data. When the MAC processing unit 63 has not received the second data (has received only the first data) and the slave base station 122-2 having the channel being in an idle state has been determined, the MAC processing unit 63 may determine to transmit the first data even through the slave base station 122-2 is a secondary station for the terminal 14-1.

If there are a plurality of slave base stations 122 whose channels have been determined to be in the idle state (step S113; Yes), the processing proceeds to step S114. When there are a plurality of destination terminals 14 as in a case where the MAC processing unit 63 receives the first data addressed to the terminal 14-1 and the second data addressed to the terminal 14-1 (step S114; Yes), the processing proceeds to step S115.

In a step S115, the MAC processing unit 63 transmits the data through multi-user MIMO (MU-MIMO) that uses the plurality of slave base stations 122 whose channels have been determined to be in the idle state in a coordinated manner. For example, when the slave base stations 122-1 and 122-2 are determined to have the channels being in the idle state, the MAC processing unit 63 determines a transmission weight as described with reference to FIG. 6, and transmits information indicating the first MAC frame, the second MAC frame, and the transmission weight to each of the slave base stations 122-1 and 122-2. The slave base stations 122-1 and 122-2 process the first MAC frame and the second MAC frame according to the transmission weight to generate radio signals, and emit the radio signals via the antennas.

If the number of destination terminals 14 is one, as in the case where the MAC processing unit 63 has received the first data addressed to the terminal 14-1 but not received the second data addressed to the terminal 14-2 (step S114; No), the processing proceeds to step S116. In step S116, the MAC processing unit 63 transmits the data via any of the plurality of slave base stations 122 whose channel is determined to be in the idle state. For example, if the slave base stations 122-1 and 122-2 have been determined to have the channels being in the idle state, the MAC processing unit 63 may use the slave base station 122-1 that is the primary station for the terminal 14-1 in signal transmission. In this case, the MAC processing unit 63 transmits the first MAC frame to the slave base station 122-1, and the slave base station 122-1 converts the first MAC frame received from the MAC processing unit 63 into a radio signal, and emits the radio signal via the antenna. Alternatively, the MAC processing unit 63 may perform signal transmission by using the slave base stations 122-1 and 122-2 in coordinated manner.

As described above, in the present embodiment, the master base station 121 performs the main part of the MAC layer processing including the generation of MAC frames and the management of terminal attribution. For example, the master base station 121 representatively performs carrier sensing of the slave base stations 122. Specifically, the master base station 121 uses an access parameter common to the slave base stations 122 to determine whether the channel of each of the slave base stations 122 is in the idle state or the busy state. Thus, the transmission timing can be synchronized among the slave base stations 122, and multi-user MIMO that uses the slave base stations 122 in a coordinated manner can be performed. By performing multi-user MIMO that uses the slave base stations 122 in a coordinated manner, interference that would occur among the terminals on the reception side can be reduced.

For example, the master base station 121 generates MAC frames including the same MAC address. Thus, the base station system 12 operates as one access point with respect to the terminals 14. For example, even if a terminal 14 moves from the service area 123-1 of the slave base station 122-1 to the service area 123-2 of the slave base station 122-2, the wireless link between the terminal 14 and the base station system 12 is maintained. The base station system 12 can provide a wide service area.

The master base station 121 determines a transmission weight for performing beamforming to perform multi-user MIMO transmission that uses the plurality of slave base stations 122 in a coordinated manner. Thus, the transmission weight can be efficiently determined.

The master base station 121 sets one of the slave base stations 122 capable of communicating with the terminal 14 as a primary station and the rest as secondary stations for each of the terminals 14, and notifies the slave base station 122 set as the primary station for the terminal 14 of the fact that the slave base station has been set as the primary station for the terminal 14. Thus, it is possible to avoid transmitting of the same signal to the master base station 121 from the two or more slave base stations 122. For example, when the slave base stations 122-1 and 122-2 receive a radio signal from the terminal 14-1, the slave base station 122-1 transmits the MAC frame extracted from the radio signal to the master base station 121, but the slave base station 122-2 discards the MAC frame extracted from the radio signal. The communication amount between the master base station 121 and the slave base stations 122 can be reduced.

The master base station 121 uses the slave base station 122 set as the primary station for the terminal 14 to transmit a signal to the terminal 14. In other words, the slave base station 122 in the best communication state is used for signal transmission. Thus, communication can be stably performed between the base station system 12 and the terminal 14.

### Modified Example

In the above-described embodiment, the master base station 121 is separated from any of the slave base stations 122. In other embodiments, the master base station 121 may include one of the slave base stations 122.

In the above-described embodiment, the master base station 121 performs processing of a part of the MAC layer, and each slave base station 122 performs processing of the rest part of the MAC layer and processing of the physical layer. The master base station 121 may perform a part of the processing described as processing to be performed by the slave base stations 122. In one example, the master base station 121 may process the entire MAC layer and each slave base station 122 may process the physical layer. More specifically, the error detecting unit 83, the determination unit 84 and the ACK generation unit 85 illustrated in FIG. 8 may be provided in the master base station 121.

In the above-described embodiment, each slave base station 122 includes one PHY processing unit. In other embodiments, each slave base station 122 may include a plurality of PHY processing units. For example, each slave base station 122 may include a PHY processing unit for a 2.4 GHz band and a PHY processing unit for a 5 GHz band. In this case, carrier sensing is performed for each of the PHY processing units.

At least a part of the above-mentioned processing may be realized by a processor executing a program (computer-executable commands). The program may be provided to the master base station 121 being stored in a computer-readable storage medium. In this case, for example, the master base station 121 further includes a drive (not illustrated) for reading data from the storage medium and acquires the program from the storage medium. Examples of the storage medium include a magnetic disk, an optical disk (CD-ROM, CD-R, DVD-ROM, DVD-R, or the like), a magneto-optical disk (MO or the like), and a semiconductor memory. In addition, the program may be stored in a server on the network 16, and downloaded by the master base station 121 from a server.

Further, the present invention is not limited to the above embodiments, and can be modified in various ways without departing from the scope thereof at the implementation stage. In addition, embodiments may be combined as appropriate, in which case effects of the combination can be achieved. Furthermore, the foregoing embodiments include various inventions, and various inventions can be extracted combinations selected from the multiple configuration requirements disclosed herein. For example, in a case where the problem can be solved and effects can be exhibited even if several configuration requirements described in the embodiments are removed from all of the configuration requirements, a configuration with the configuration requirements removed can be extracted as an invention.

### REFERENCE SIGNS LIST

10 Wireless communication system
12 Base station system
121 Master base station
122 Slave base station
123 Service area
14 Wireless terminal
16 Network
21 Controller
211 Processor
212 RAM
213 Program memory
22 Data memory
23 WAN module
24 Routing module
25 Wireless module
26 Wired module
31 Controller
311 Processor
312 RAM
313 Program memory
32 Data memory
33 Wireless module
34 Wired module
41 Controller
411 Processor
412 RAM
413 Program memory
42 Data memory
43 Wireless module
44 User interface
45 Battery
61 LLC processing unit
62 LLC interface
63 MAC processing unit
64 Network interface
65 Terminal management unit
66 Carrier sensing control unit
81 Network interface
82 PHY processing unit
83 Error detection unit
84 Determination unit
85 ACK generation unit

1. A base station configured to operate as a first base station in a base station system including the first base station and a plurality of second base stations, the base station comprising:
a carrier sensing control unit configured to determine whether a channel of each of the plurality of second base stations is in an idle state or a busy state by using an access parameter common to the plurality of second base stations; and
a processing unit configured to transmit a first signal to be transmitted to a first wireless terminal and a second signal to be transmitted to a second wireless terminal using multi-user MIMO which uses the two or more second base stations whose channels have been determined to be in the idle state in a coordinated manner.

2. The base station according to claim 1, wherein the processing unit acquires first data addressed to the first wireless terminal and second data addressed to the second wireless terminal, generates a MAC frame including the first data and a MAC address of an access point as the first signal, and generates a MAC frame including the second data and the MAC address of the access point as the second signal.

3. The base station according to claim 1, wherein the multi-user MIMO using the two or more second base stations in a coordinated manner includes performing beamforming with antennas included in the two or more second base stations, and
the processing unit transmits information indicating a transmission weight for the beamforming and information indicating a modulation and coding scheme (MCS) to the two or more second base stations.

4. The base station according to claim 1, further comprising:
a management unit configured to manage a state of communication between the plurality of second base stations and a plurality of wireless terminals including the first wireless terminal and the second wireless terminal, wherein
the management unit sets, for each of the plurality of wireless terminals, one of second base stations capable of communicating with the wireless terminal as a primary station, and the rest as secondary stations, and
the processing unit notifies the second base station set as a primary station for the wireless terminal of the fact that the second base station has been set as a primary station for the wireless terminal.

5. The base station according to claim 4, wherein the processing unit specifies a wireless terminal for which a second base station whose channel is determined to be in the idle state is set as a primary station from among the plurality of wireless terminals, and determines to transmit a signal to be transmitted to the specified wireless terminal.

6. A base station system comprising:
a first base station; and
a plurality of second base stations connected to the first base station, wherein
each of the plurality of second base stations includes an antenna,
the first base station includes
a carrier sensing control unit configured to determine whether a channel of each of the plurality of second base stations is in an idle state or a busy state by using an access parameter common to the plurality of second base stations, and
a processing unit configured to transmit a first signal to be transmitted to a first wireless terminal and a second signal to be transmitted to a second wireless terminal using multi-user MIMO which uses the two or more second base stations whose channels have been determined to be in the idle state in a coordinated manner, and
each of the two or more second base stations receives the first signal and the second signal from the first base station, and transmits the first signal and the second signal via the plurality of antennas.

7. A communication method performed by a first base station in a base station system including the first base station and a plurality of second base stations, the communication method comprising:
determining whether a channel of each of the plurality of second base stations is in an idle state or a busy state by using an access parameter common to the plurality of second base stations; and
transmitting a first signal to be transmitted to a first wireless terminal and a second signal to be transmitted to a second wireless terminal using multi-user MIMO which uses the two or more second base stations whose channels have been determined to be in the idle state in a coordinated manner.
